(19) United States
(12) Patent Application Publication
(10) Pub. No.: US 2016/0005033 A1
(43) Pub. Date: Jan. 7, 2016

(54) SYSTEMS AND METHODS FOR A CURRENCY EXCHANGE PLATFORM

(71) Applicant: 8Exchange, LLC, Miami, FL (US)

(72) Inventor: Boris Maximilian Flick von Zitzewitz, Las Palmas de Gran Canaria (ES)

(21) Appl. No.: 14/792,575

(22) Filed: Jul. 6, 2015

Related U.S. Application Data
(60) Provisional application No. 62/020,994, filed on Jul. 3, 2014.

(51) Int. Cl. G06Q 20/38; G06F 17/30

(52) U.S. Cl. CPC G06Q 20/381; G06F 17/30528

(57) ABSTRACT

A system for matching a currency exchange request of a first user with a corresponding request of a second user includes a controller configured to receive the currency exchange request, wherein the currency exchange request includes a first amount of a first currency to be converted to a second currency, a memory coupled to the controller configured to store program instructions executable by the controller, a database of one or more second users having associated currency exchange requests, and a database of exchange rates. A mobile application includes a user interface for submitting the currency exchange request, and the memory causes the controller to prompt, via the user interface, selection of the first currency, input of the first amount of the first currency, and selection of the second currency into the currency exchange request prior to submission.

### CROSS-REFERENCE TO RELATED APPLICATIONS

This application incorporates by reference and claims priority to U.S. Provisional Application Patent No. 62/020,994 filed Jul. 3, 2014.

### BACKGROUND OF THE INVENTION

The present subject matter relates generally to systems and methods configured to connect users to exchange currency. Specifically, the present subject matter provides a mobile platform through which users can identify and execute peer-to-peer, in-person, currency exchanges.

Typically, international travelers exchange currency at a currency exchange business before leaving their original country or upon arrival at a destination country. The travelers may use currency exchange businesses in their town or in the airport. These exchange businesses typically charge a customer a fee for exchanging currency. The amount charged as the fee may vary depending on the exchange business. For example, the exchange fee at a currency exchange establishment at the airport may be higher or lower than the exchange fee at a currency exchange establishment in the country of origin or destination. As a result, customers have difficulty in determining which currency exchange business has the lowest exchange fee. Further, even if a customer does determine a certain establishment as having the lowest exchange rate, the establishment may not be in a convenient location. For example, many travelers wish to exchange currency during traveling, such as in the airport before leaving for the destination country, or when arriving at the destination country. However, the airport exchange currency businesses may not have the lowest exchange fee.

In addition, exchange currency establishments may quote various exchange rates that differ depending on which exchange currency establishment a customer uses. For example, exchanging currency at a currency exchange business located in one country may quote an exchange rate that is different from an exchange rate quoted at a currency exchange business in a different country with respect to the same currency exchange transaction. As a result customers may lose money during the exchange based on the various exchange rates.

These problems and challenges are due, at least in part, to the manner in which currency exchange businesses operate. But without the currency exchanges, there is no identifiable, on-demand, location to make a currency exchange.

As a result, there is a need for mobile based, peer-to-peer, currency exchange systems and methods that enable users to overcome these challenges.

### BRIEF SUMMARY OF THE INVENTION

The present disclosure provides systems and methods for exchanging currency between users within a physical vicinity to each other. In a primary embodiment, the systems and methods are embodied in a mobile application that provides users a peer-to-peer platform for identifying opportunities to meet other users for conducting efficient and fair, in-person currency exchanges. Various examples of the systems and methods are provided herein.

The system connects users with compatible currency exchange requests and within a predetermined proximity to each other. Based on the connection generated by the system, the system communicates the customers' contact information to each other such that users may meet to physically exchange the requested currency without being subject to exchange fees associated with typical exchange currency methods and businesses. The contact information may be a customer's phone number, email address, instant message identification, or any other contact identification. In an example, the contact information is a customer identifier within the system, for example a user identifier, which a customer may use to message the customer associated with the user identifier. In other words, the system may include a message platform for customers to communicate with each other to establish exchange details.

An advantage of the present system is connecting appropriate users that seek to exchange currencies, wherein the users have compatible exchange requests.

A further advantage of the present systems and methods is providing a currency exchange method that avoids imposed exchange fees associated with conventional currency exchange platforms.

Another advantage of the present systems and methods is connecting customers to physically exchange currencies based on the physical proximity of the customers to each other.

Yet another advantage of the present systems and methods is providing a confidential platform for customer to communicate with each other without disclosing private or personal information.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a front view of an embodiment of a user interface displaying a menu within the system disclosed herein to connect with various social network platforms.

FIG. 2 is a front view of an embodiment of a user interface displaying a menu and options within the system disclosed herein.

FIG. 3 is a front view of an embodiment of a user interface displaying a map feature graphically identifying second customers within a defined proximity of the first customer.

FIG. 3A is a front view of an embodiment of a user interface displaying a list of second customers associated with a currency exchange request.

FIG. 4 is a front view of an embodiment of a user interface displaying input options for creating a new exchange request.

FIG. 5 is a front view of an embodiment of a user interface displaying a list of exchange requests created by the first customer.

FIG. 5A is a front view of an embodiment of a user interface displaying details of a currency exchange request.

FIG. 5B is a front view of an embodiment of a user interface displaying offers related to the currency exchange request.

FIG. 5C is a front view of an embodiment of a user interface displaying details of a related offer.

FIG. 5D is a front view of an embodiment of a user interface displaying messages between the first customer and a second customer.

FIG. 6 is a front view of an embodiment of a user interface displaying a list of exchange offers associated with the first customer.

FIG. 7 is a front view of an embodiment of a user interface displaying a message history associated with the first customer.

FIG. 8 is a front view of an embodiment of a user interface displaying a currency converter within the system disclosed herein.

FIG. 9 is a front view of an embodiment of a user interface displaying a setting option within the system disclosed herein.

FIG. 10 is a schematic representation of an embodiment of the system of the present invention.

FIG. 11 is a flow chart illustrating the steps of a method of operating the system of the present invention.

FIG. 12 is a front view of an embodiment of a user interface displaying exchanger filters.

### DETAILED DESCRIPTION OF THE INVENTION

The present disclosure is directed to systems 100 and methods 101 for matching a currency exchange request 102 of a first user 104 with currency exchange requests 106 of one or more second users 108 who have requested a partially or fully matching currency exchange request 106. For example, if a first user 104 requests to exchange United States dollars (USD) to Euros, the system 100 facilitates the selection a second user 108 from a database 124 of a plurality of users 104, 108 having associated currency exchange requests 102, 106 who has requested to exchange Euros for USD in a quantity that makes a meaningful exchange possible. The selection of the second user 108 may be based on the second user's requested currency type and amount and the first user's request currency type and amount. The selection of the second user 108 may also be based on the location of the second user 108. For example, the system 100 selects a second user 108 having an associated location identifier that is within a given proximity, for example 20 miles, of a location identifier of the first user 104.

The users 104, 108 may enter their location identifier into the system 100, such as in an associated user profile within the system 100. Alternatively, the system 100 may include or be in communication with a GPS system within an electronic device associated with the user 104, 108. For example, the system 100 may automatically input a location identifier of a second user 108 into the database 124 based on the GPS data of the smart phone associated with the second user 108.

Once the system 100 facilitates the selection of at least one second user 108, the system 100 communicates the first and/or second users' respective contact information to enable the users 104, 108 to physically meet to exchange the currency. As a result of the system 100, users 104, 108 may exchange currencies without being subject to exchange fees that are typically associated with conventional currency exchange transactions. Further the users 104, 108 may use an exchange rate that they agree upon, or that is suggested by the system 100.

Although described primarily with respect to one to one transactions, it is understood that the systems 100 and methods 101 described herein may be adapted to facilitate currency exchanges between three or more users. Such examples will be apparent to those skilled in the art based on the disclosure provided herein. For example, a first user 104 may desire to convert USD to Euro, a second user 108 may desire to convert Euro to Yen, and a third user 108 may desire to convert Yen to USD. If the location and quantity to be exchanged between the three users are matches that can fulfill the desires of each user, a three-user match may be facilitated. Of course, more complex matching may be facilitated as well, including a greater number of users and/or a greater number of currencies. For example, the systems 100 and methods 101 may be used to facilitate the exchange of four currencies between a first user 104 and a second user 108.

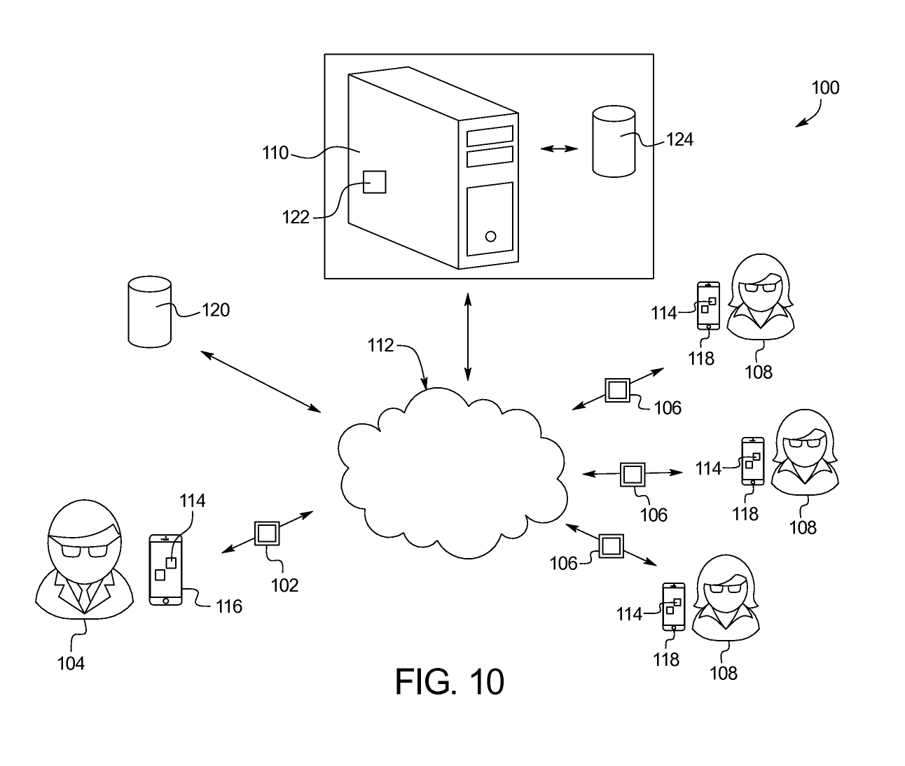

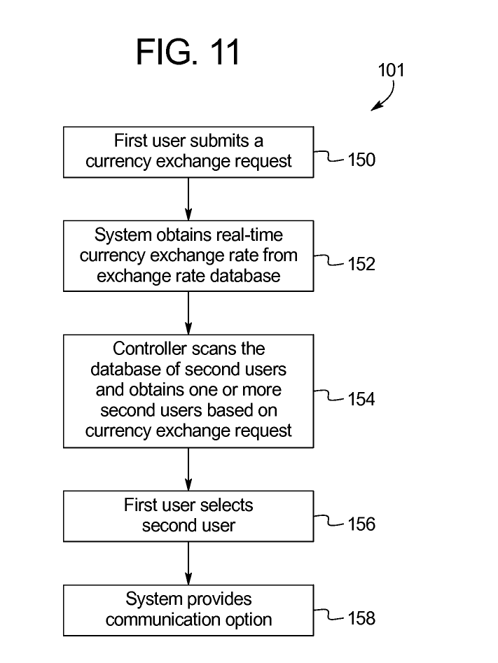

Turning to FIGS. 10 and 11, examples of the system 100 and method 101 are illustrated. FIG. 10 illustrates an example of a system 100 for matching a currency exchange request 102 of a first user 104 with a corresponding request 106 of a second user 108. A controller 110 facilitates communications between the first and second users 104, 108. The controller 110 may, for example, receive the currency exchange requests 102, 106 from the first and second users 104, 108, respectively, over a network 112, such as the Internet.

The system 100 may include a mobile device application 114 that may be installed on devices 116, 118 of the first and second users 104, 108 that permits the first and second users 104, 108 to submit the currency exchange requests 102, 106 to the controller 110. In an alternative embodiment, the mobile device application 114 may instead be a web application or other application hosted outside of the devices 116, 118 of the first and second users 104, 108. For example, the application may be hosted in the controller 110 and accessed by the first and second users 104, 108 through their devices 116, 118. The currency exchange request 102 may include first location identifying information (e.g., derived from GPS information, manually entered, etc.) and a first amount of a first currency that the first user would like to convert into a second currency. The mobile application 114 may then utilize a currency exchange rate obtained from a database 120 of real-time currency exchange rates via the network 112 to determine a value for the first and/or second currency to be used when identifying a matching exchange request.

As further shown in FIG. 10, a memory 122 configured to store program instructions executable by the controller 110 is coupled to the controller 110. Upon receipt of the currency exchange request 102, the controller 110 communicates with a database 124 of second customers 108 having associated currency exchange requests 106 that may include second location identifying information and a second amount of the second currency that the second customer would like to convert into the first currency. The controller 110 may scan the database 124 to identify one or more second customers 108 having associated currency exchange requests 106 that are within a specific distance of the first customer 104. For example, the controller 110 may identify one or more second customers 108 within a radius of 10 miles of the first customer 104.

The controller 110 may then deliver the list of proximate one or more second customers 108 and associated contact information to the device 116 of the first customer 104. The first customer 104 may then contact the second customer 108 by phone, email or through a direct message, for example, a direct message communicated through the mobile device application 114.

FIG. 11 illustrates a method of operating the system 100 of FIG. 10. In the first step 150, the first user 104 submits a currency exchange request 102. In the second step 154, the system 100 obtains a real-time currency exchange rate from the database 120. The controller 110 scans the database 124 of second users 108 and identifies one or more second users 108 having a corresponding currency exchange request 106 in step three 154. In step four 156, the first user 104 selects a second user 108. In step five 158, the system 100 provides a communication option such as a phone number, an email address or a direct message.

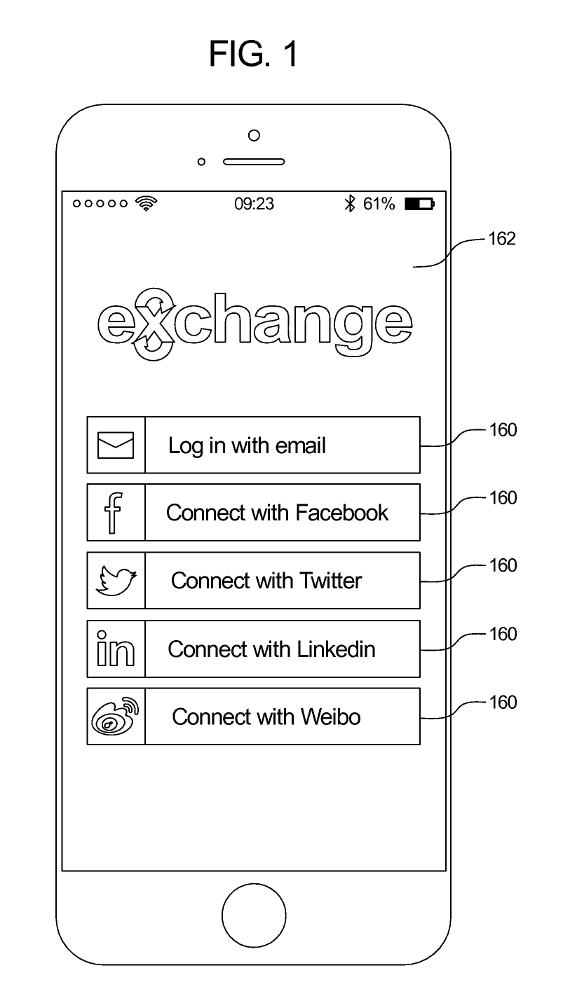

As described, the systems 100 and methods 101 may be embodied in a mobile device application 114 that may be installed on devices 116, 118 of the first and second users 104, 108. Accordingly, the devices 116, 118 may present the first and second users 104, 108 with various users interfaces adapted to facilitate the various functionality described herein. FIGS. 1-9 illustrate various user interfaces provide in one example of a mobile device application 114 embodying the systems 100 and methods 101.

In an example, as shown in FIG. 1, the system 100 may provide a login screen 162 in communication with one or more social network platforms 160. The examples shown include Facebook®, Twitter®, LinkedIn®, and Weibo®, but it is understood the system 100 may be in communication with any social network platform 160. In one embodiment, the login screen 162 enables the user 104 to log in using one of the social network platforms 160. In such example, the shared contact information may be identifiers associated with the social network platforms 160. Alternatively, in other embodiments, the login screen 162 enables the user 104 to log directly into the system 100 without connecting through a social network platform 160.

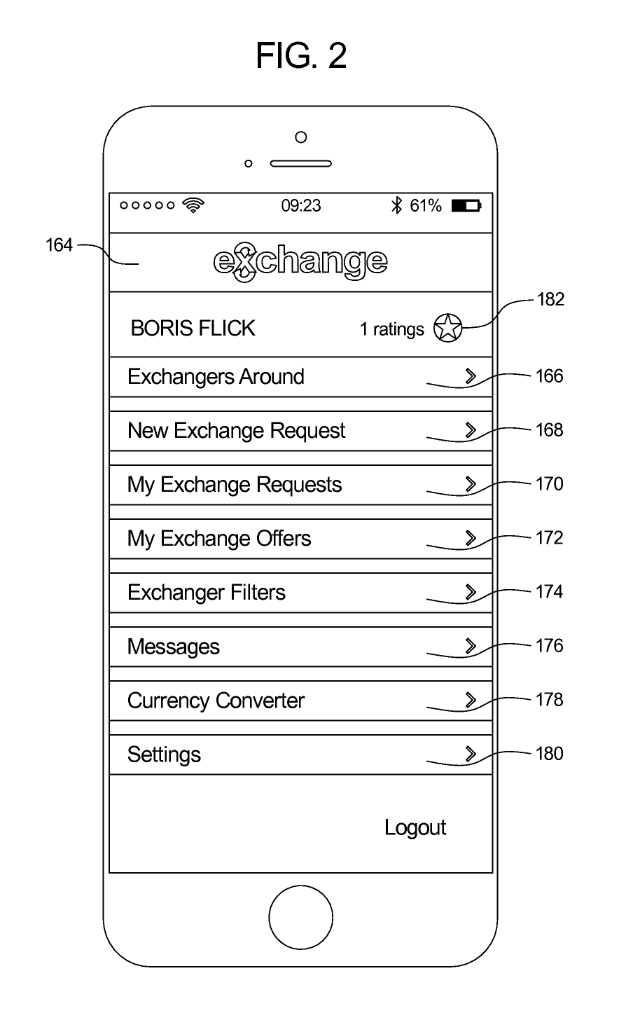

FIG. 2 illustrates a home screen 164 including first through eighth prompts or options 166-180 through which the user 104 may manage his exchange requests and communications with second users 108. The selection of each prompt or option leads the user 104 to a further screen within the user interface as described below. As shown, the home screen 164 may also provide a rating 182 of the user 104 based on interactions with other users 108.

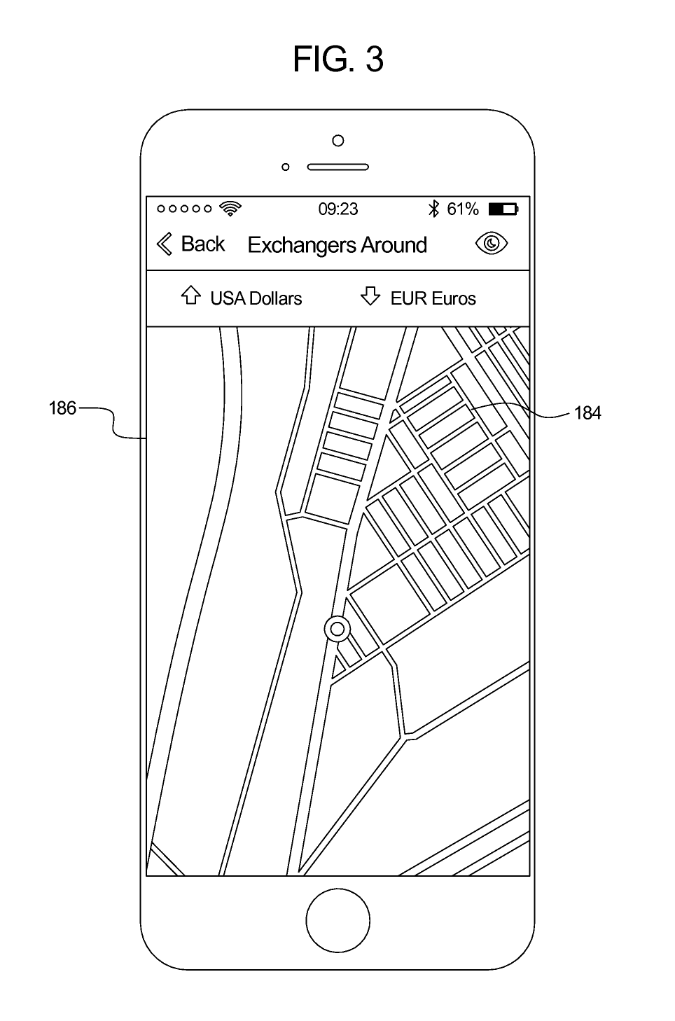

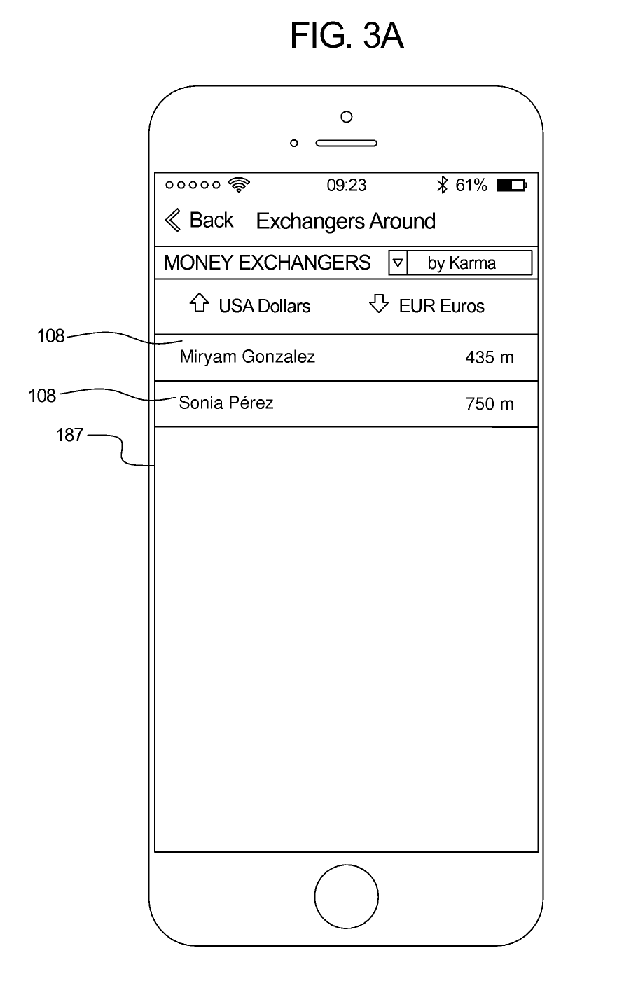

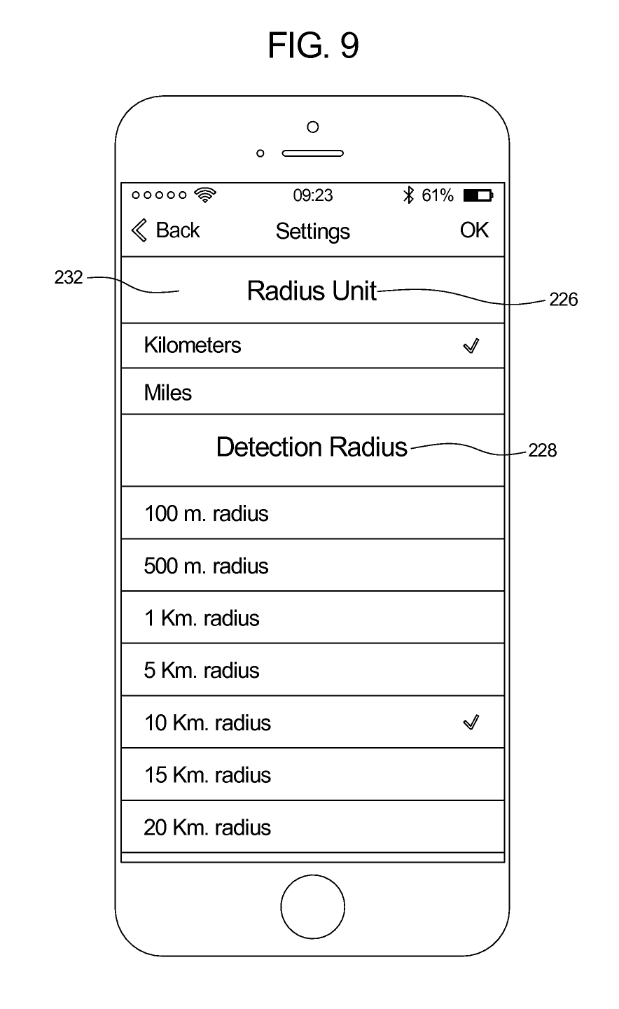

Selection of the first prompt 166 shown on the home screen 164 in FIG. 2 allows the user 104 to view a map 184 showing the locations of the one or more second users 108 proximate to the first user 104, as shown in the map screen 186 shown in FIG. 3 (titled “Exchangers Around” in FIGS. 2 and 3). Alternatively or in addition to the map screen 186, the system 100 may provide a user interface that includes functionality to help a user 104 identify the other “exchangers around,” such as a list of the second customers 108 and the distance from the first customer 104 to the second customer 108 as shown in the exchangers around screen 187 FIG. 3A. In some embodiments, first customers 104 and second customers 108 may turn on and off the capability of locating the users 104, 108. For example, if a second customer 108 did not want to disclose his location, he could deny permission of this feature within the settings screen 232, as shown in FIG. 9.

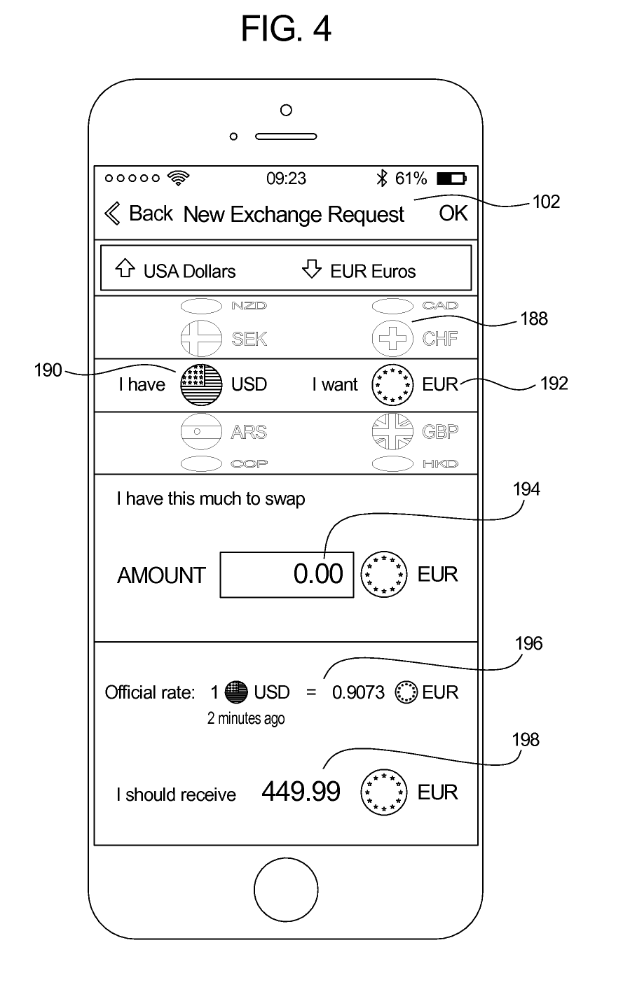

Selection of the second prompt 168 shown on the home screen 164 of FIG. 2 enables the user 104 to submit a new currency exchange request 102 through a new currency exchange request screen 188, as shown in FIG. 4. Via the new currency exchange request screen 188, the user 104 selects the first and second currencies 190, 192 and inputs the amount of the first currency 194 via the user interface 188. The controller 110 may obtain a currency exchange rate 196 from database 120, and then generate a second amount of the second currency 198 based on the exchange rate 196. The first user 104 may then submit a new exchange request based on the first currency 190 and the calculated second amount of the second currency 198. For example, the first user 104 may submit an exchange request that includes a second amount of the second currency 198 that he or she wishes to obtain based on the first amount of the first currency 194. It is also contemplated that the new exchange request screen 188 may enable calculations in reverse of the previous description. For example, the first user 104 may calculate the amount of the first currency 194 needed to exchange based on the amount of the second currency 198 desired.

In response to the initiation of a new currency exchange request 102 via the currency exchange request screen 188, the system 100 may display the new exchange request 102 to second users 108 and continually update the second amount of the second currency 198 based on the real-time currency exchange rates. For example, if the first user 104 submits a new currency exchange request 102 on a first date and a second user 108 does not initiate an exchange until three days later, the exchange rate may be different when the second user 108 initiates the exchange than it was when the first user 104 submitted the request 102. The first user 104 may choose to lock in the exchange rate on the day the new request 102 was submitted, or the first user 104 may choose for the system 100 to continually update the exchange rate 194 to reflect real time exchange rates.

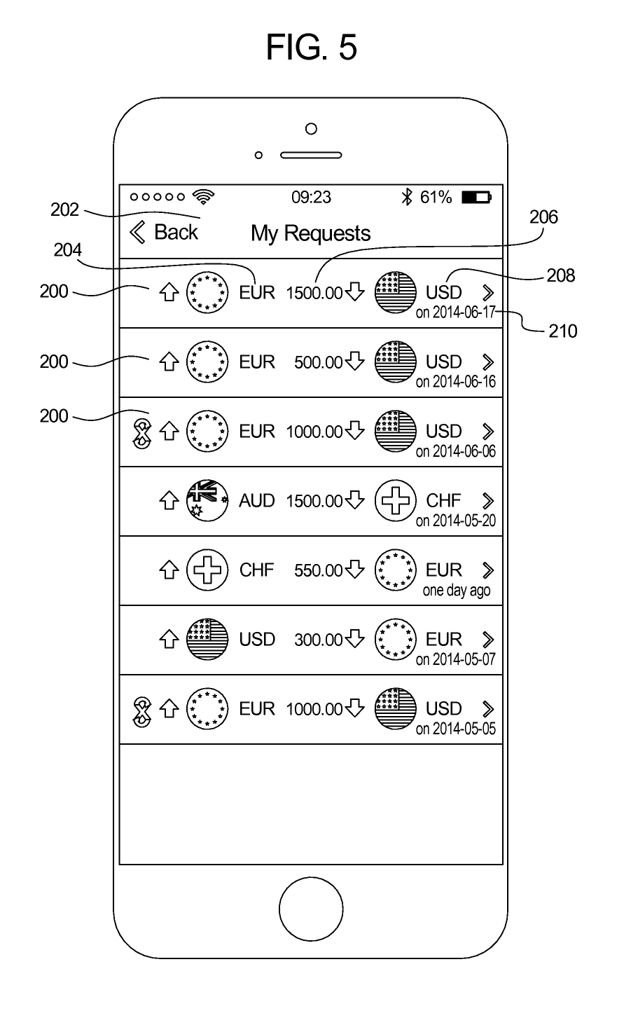

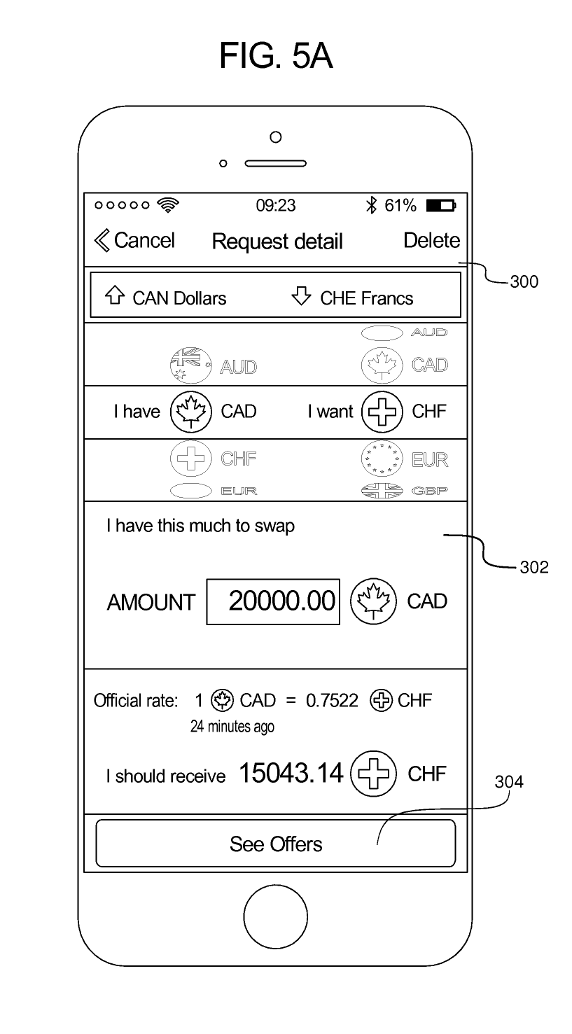

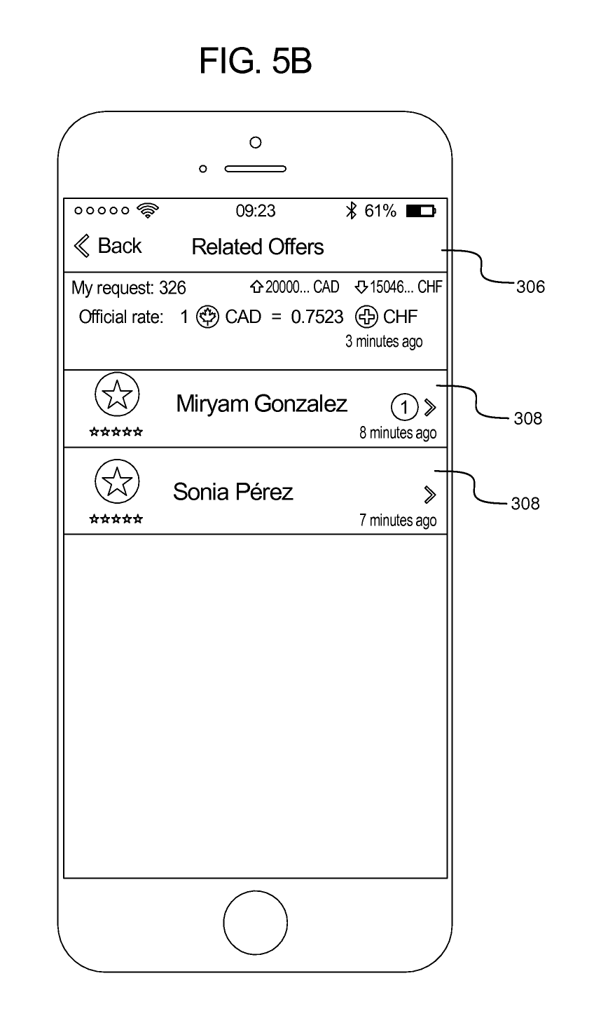

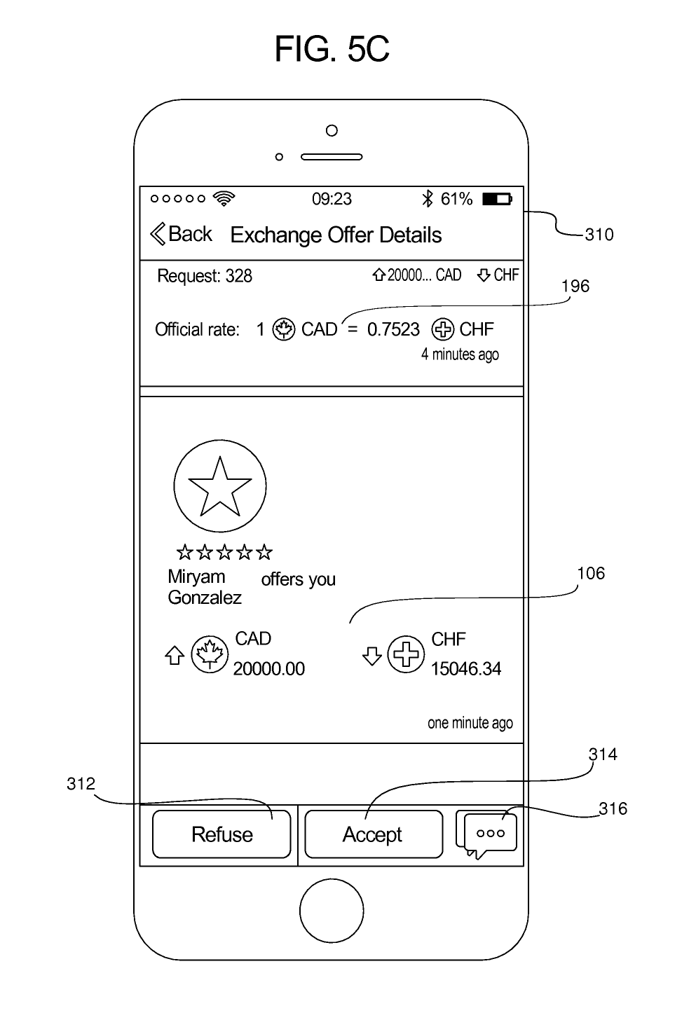

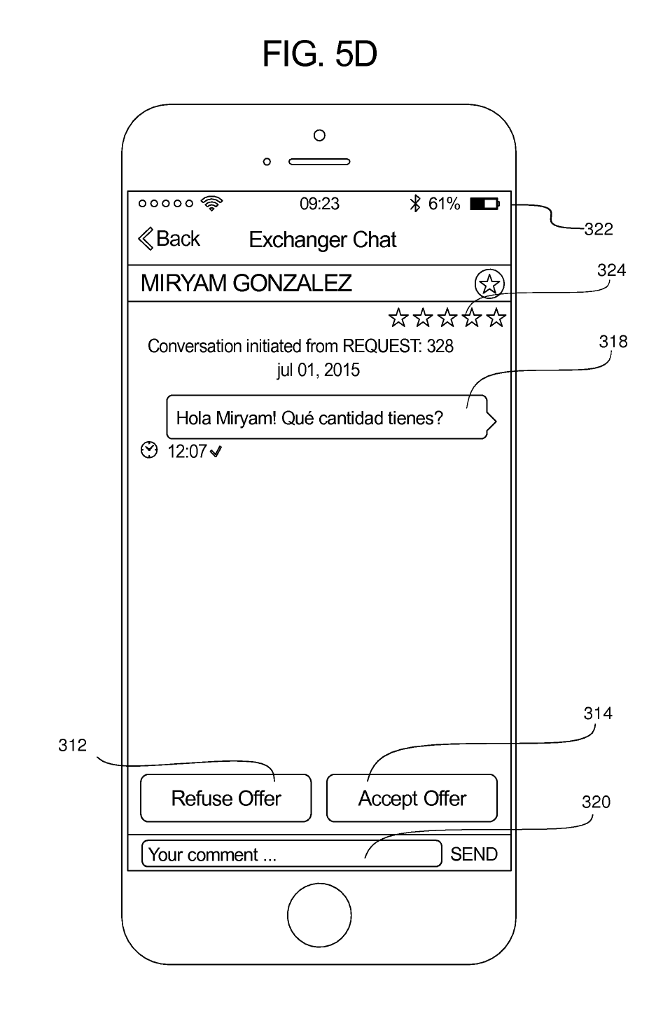

Using the third prompt 170 shown on the home screen 164 of FIG. 2, the user 104 may view a list of the currency exchange requests 200 that the user 104 has submitted in the currency exchange request history screen 202 shown in FIG. 5. Each listed request 200 includes the first currency 204, the calculated amount of the second currency 206, and the second currency 208. The date of submission 210 of the currency exchange request may also be included, as well as the details of the transaction including, for example, the contact information of the second user 108, the location of the exchange, any notes saved related to the exchange, etc.

The first user 104 may select one of the listed requests 200, which takes the first user 104 to a request detail screen 300 shown in FIG. 5A. The request detail screen 300 allows the first user 104 to view the request details 302 and select a further prompt 304 to view related offers. Using the further prompt 304, the first user 104 may view the related offers screen 306 seen in FIG. 5B. The related offers screen 306 shows a list of one or more offers 308 from second users 108 offering a second amount of the second currency in exchange for the first amount of the first currency. The user 104 may select one of the related offers 308, which leads the first user 104 to the exchange offer detail screen 310 shown in FIG. 5C. The exchange offer detail screen 310 identifies the exchange rate 196 and the corresponding exchange request 106 of the second user 108. The user 104 may refuse or accept the offer 308 by selecting the refuse option 312 or the accept option 314, respectively, on the exchange offer detail screen 310. The first user 104 may also initiate a chat with the second user 108 by selecting the chat option 316. The chat option 316 leads the user 104 to an exchanger chat screen 322 illustrated in FIG. 5D, where the user 104 may receive messages 318 from the second user 108 and may submit messages to the second user 108 via an input 320. The first user 104 may also refuse or accept the offer 308 by selecting the refuse option 312 or the accept option 314, respectively, on the exchanger chat screen 322. In one embodiment, the exchanger chat screen 322 also allows the first user 104 to assign a rating 324 to the second user 108 by selecting one through five stars.

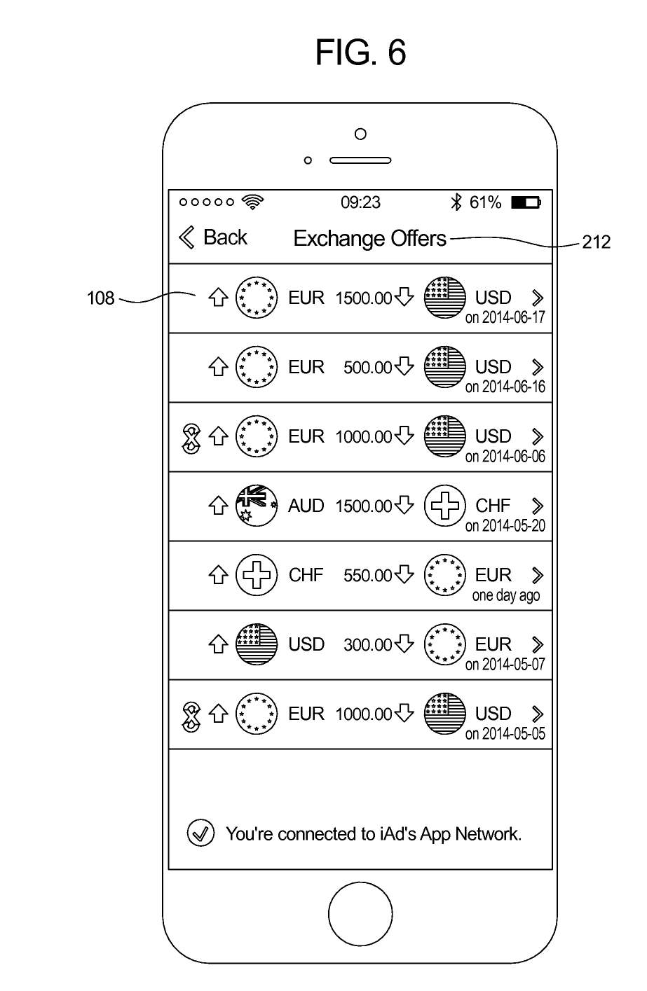

Selection of the fourth prompt 172 shown on the home screen 164 of FIG. 2 takes the first user 104 to a currency exchange offers screen 212 that allows the user 104 to view a list of the one or more second users 108 identified by the controller 110 in response to the current one or more outstanding new currency exchange requests 102, as shown in FIG. 6. The controller 110 may generate, and the currency exchange offers screen 212 may display, a list of one or more second users 108 having currency exchange requests 106 that correspond to the currency exchange request 102 of the first customer 104. In one embodiment, only perfectly matching corresponding currency exchange requests 106 may be displayed. In another embodiment, the corresponding currency exchange requests 106 of the one or more second users 108 may be in an amount different than the amount 198 requested by the first user 104 in the currency exchange request 102. In fact, the degree of matching required before a corresponding currency exchange request 106 is displayed on the currency exchange offers screen 212 may be controlled by the first user 104 through one or more settings within the system 100.

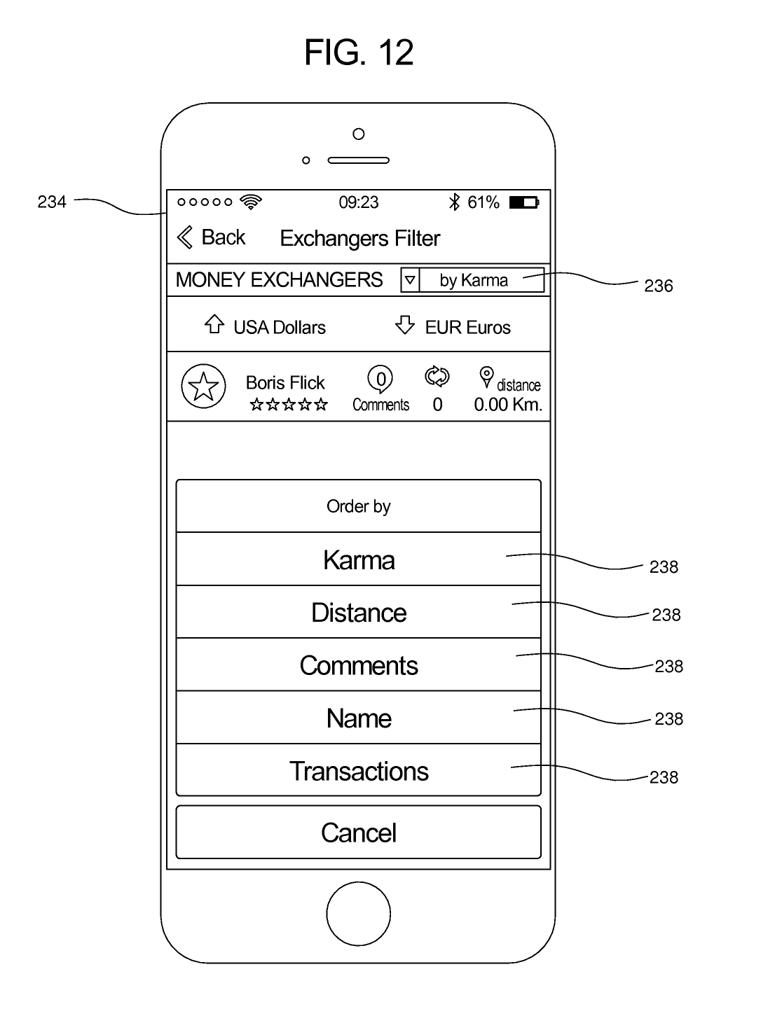

For example, the currency exchange offers screen 212 may include an adjustable setting by which the first user 104 controls the degree of matching required before a corresponding currency exchange request 106 is displayed on the currency exchange offers screen 212. Alternatively, such controls may be provided in an exchange filters screen accessible through the home screen 164 by selecting the fifth prompt 174 shown in FIG. 2. The exchange filter screen 234 shown in FIG. 12 may include a menu 236 allowing the first user 104 to organize relevant second users 108 according to specific details 238 such as karma, i.e., ratings, distance, comments, name, and transactions. Other filters and options that may be selected include the inclusion and exclusion of specific second users 108 to be matched for currency exchange requests 106, times that the first user 104 is available to be matched and times the first user 104 is unavailable for matches, etc.

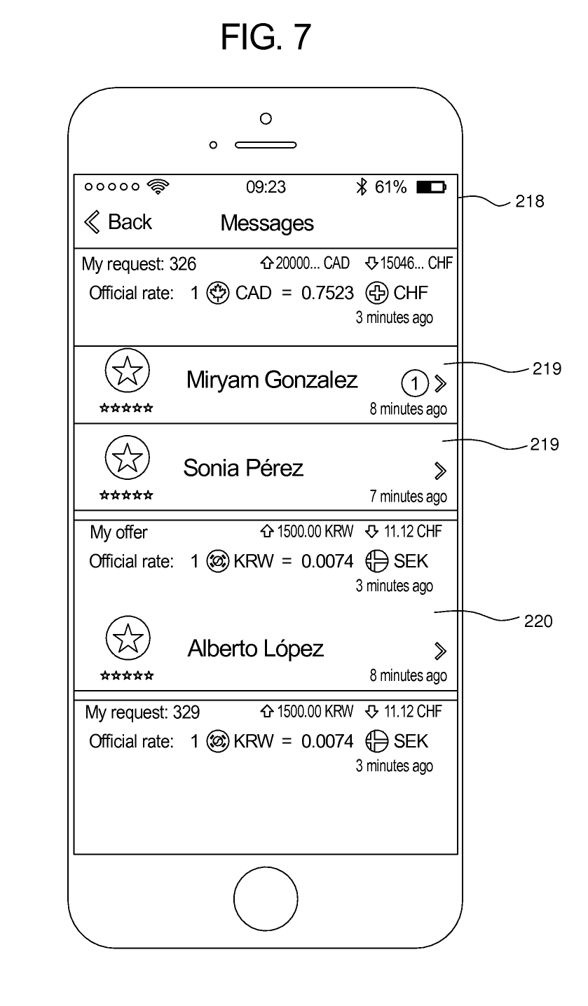

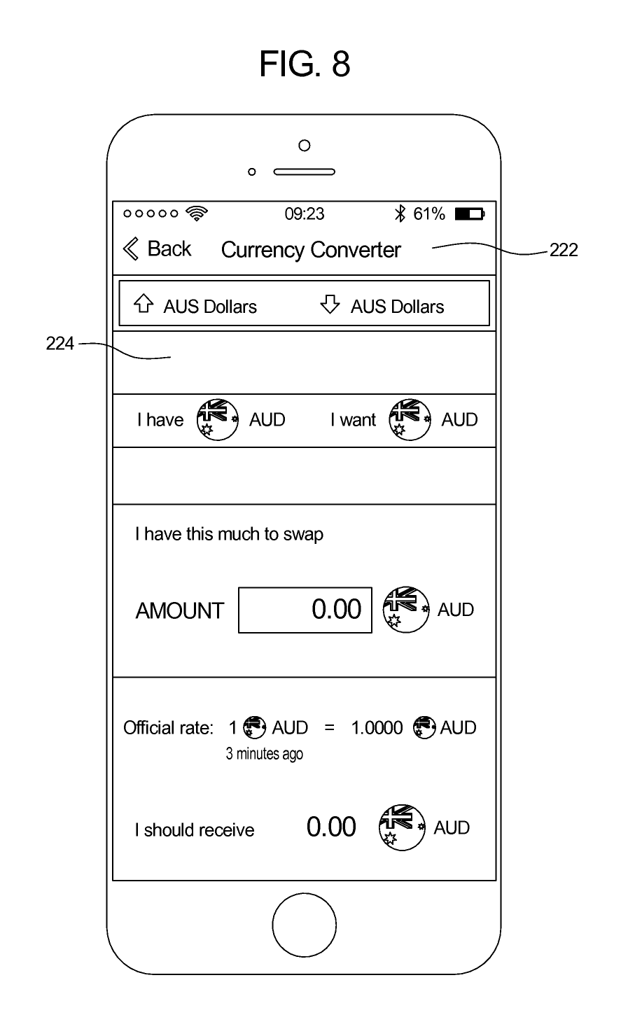

In the illustrated embodiment, the system 100 may include a message platform 214 for the users 104, 108 to communicate with each other. In one embodiment, when establishing communication between a first user 104 and second user 108, the system 100 may communicate an identifier of the second user 108 to the first user 104, wherein the identifier enables direct communication between the users 104, 108 through the system 100. Accordingly, in one example of the system 100, selection of the sixth prompt 176 of the home screen 164 of FIG. 2 enables to the user 104 to view a list of messages 216 with other users 108 via a message screen 218, as shown in FIG. 7. The message screen 218 may include messages 219 to second users 108 regarding the first user's currency exchange requests 102 as well as messages 220 to other users 108 in response to their currency exchange requests 102. The message platform 214 may enable anonymous messaging, such that the system 100 does not need to disclose external contact information or any personal information of either the first user 104 or the second user 108. In other words, the system 100 provides a confidential method of communicating between matched users 104, 108. The users 104, 108 may then communicate directly with each other and use their own discretion regarding what information to disclose to one another in order to coordinate a meeting to exchange currency. The message history screen 218 may store all or a portion of the communications between the first customer 104 and various second customers 108. In order to facilitate the currency exchanges described herein, the controller 110 may be in communication with a database 120 that is continually and automatically updated to reflect the current exchange rates between a plurality of currencies. As shown in FIG. 8, the system 100 may include a currency converter 222 that may access the most up-to-date currency exchange rates in order to calculate a fair exchange of currencies between customers 104, 108. Customers 104, 108 may use the currency converter 222 to calculate various currency exchange amounts based on real-time exchange rates.

By selection of the seventh prompt 178 shown on the home screen 164 of FIG. 2 the user 104 is provided a currency converter screen 222, as shown in FIG. 8. The currency converter screen 222 includes a currency conversion calculator 224 that enables the first user 104 to calculate currency conversions, as will be appreciated by those skilled in the art based on the disclosures provided herein.

Finally, the first user 104 may use the eighth prompt 180 shown on the home screen 164 of FIG. 2 access a settings screen 232 to modify the radius unit 226 and distance 228 to be used when doing the matching associated with a new currency exchange request 102. Users 104, 108 may use the settings screen 232 to specify other information such as profile information, availability of contact information, location identifying information, etc.

As described above, aspects of the systems 100 and methods 101 described herein are controlled by one or more controllers 110. The one or more controllers 110 may be adapted to run a variety of application programs, access and store data, including accessing and storing data in the associated databases 124, and enable one or more interactions as described herein. Typically, the controller 110 is implemented by one or more programmable data processing devices. The hardware elements, operating systems, and programming languages of such devices are conventional in nature, and it is presumed that those skilled in the art are adequately familiar therewith.

For example, the one or more controllers 110 may be a PC based implementation of a central control processing system utilizing a central processing unit (CPU), memory 122 and an interconnect bus. The CPU may contain a single microprocessor, or it may contain a plurality of microprocessors for configuring the CPU as a multi-processor system. The memory 122 may include a main memory, such as a dynamic random access memory (DRAM) and cache, as well as a read only memory, such as a PROM, EPROM, FLASH-EPROM, or the like. The system 100 may also include any form of volatile or non-volatile memory 122. In operation, the memory 122 stores at least portions of instructions for execution by the CPU and data for processing in accord with the executed instructions.

The one or more controllers 110 may also include one or more input/output interfaces for communications with one or more processing systems. Although not shown, one or more such interfaces may enable communications via a network 112, e.g., to enable sending and receiving instructions electronically. The communication links may be wired or wireless.

The one or more controllers 110 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller 110. For example, the one or more controllers 110 may include a graphics subsystem to drive the output mechanism. The links of the peripherals to the system may be wired connections or use wireless communications.

Although summarized above as a PC-type implementation, those skilled in the art will recognize that the one or more controllers 110 also encompasses systems such as host computers, servers, workstations, network terminals, and the like. Further, one or more controllers 110 may be embodied in a device 116, 118, such as a mobile electronic device 116, 118, like a smartphone or tablet computer. In fact, the use of the term controller 110 is intended to represent a broad category of components that are well known in the art.

Hence aspects of the systems 100 and methods 101 provided herein encompass hardware and software for controlling the relevant functions. Software may take the form of code or executable instructions for causing a controller 110 or other programmable equipment to perform the relevant steps, where the code or instructions are carried by or otherwise embodied in a medium readable by the controller 110 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a controller 110 for execution. Such a medium may take many forms. Non-volatile storage media include, for example, optical or magnetic disks, such as any of the storage devices in any computer(s) shown in the drawings. Volatile storage media include dynamic memory 122, such as the memory 122 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 110 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

I claim:

1. A system for matching a currency exchange request of a first user with a corresponding request of a second user, comprising:
a controller configured to receive the currency exchange request, wherein the currency exchange request includes a first amount of a first currency to be converted to a second currency;
a memory coupled to the controller configured to store program instructions executable by the controller;
a database of one or more second users having associated currency exchange requests, wherein each associated currency exchange request includes a second amount of the second currency to be converted to the first currency; and
a database of exchange rates;
wherein a mobile application includes a user interface for submitting the currency exchange request,
wherein the memory causes the controller to prompt, via the user interface, selection of the first currency, input of the first amount of the first currency, and selection of the second currency into the currency exchange request prior to submission;
wherein the currency exchange request obtains an exchange rate from the database of exchange rates; and
wherein the controller receives the currency exchange request from the first user, matches one or more second users to the first user based on the corresponding currency exchange requests, and provides a communication option to one of the first and second users.

2. The system of claim 1, wherein the currency exchange request further includes a first location identifier of the first user, wherein the database includes second location identifier associated with each second user, and wherein the system matches one or more second users located within a distance to the first user.

3. The system of claim 2, wherein the distance is 20 miles.

4. The system of claim 2, wherein the system includes a map indicating each second location identifier of the one or more second users within the distance of the first user.

5. The system of claim 1, wherein the communication option comprises contact information associated with one of the first and second users.

6. The system of claim 1, wherein the communication option comprises a message between the first and second users.

7. The system of claim 1, wherein the system is in communication with a social network platform.

8. The system of claim 7, further comprising a further database including a plurality of real-time exchange rates between a plurality of currencies.

9. The system of claim 8, wherein the controller obtains a real-time exchange rate for the currency exchange request.

10. The system of claim 9, wherein the system continually updates the exchange rate to reflect real-time exchange rates after the currency exchange request has been submitted.

11. The system of claim 10, wherein the system is configured to allow the first user to lock in the exchange rate at the time the currency exchange request is submitted.

12. A method of matching a currency exchange request of a first user with a corresponding request of a second user, comprising the steps of:
providing a system comprising a controller and a database, wherein the database of one or more second users having associated currency exchange requests and associated second location identifiers;
receiving the currency exchange request from the first user, wherein the currency exchange request includes a first location identifier of the first user and a first amount of a first currency to be converted to a second currency; and
matching one or more second users to the first user, wherein each associated currency exchange request includes a second amount of the second currency to be converted to the first currency;
wherein the one or more second users are within a distance of the first user.

13. The method of claim 12, wherein the system further comprises a further database including a plurality of real-time exchange rates between a plurality of currencies.

14. The method of claim 13, further comprising the step of providing a real-time exchange rate for the currency exchange rate request.

15. The method of claim 14, wherein the system continually updates the exchange rate to reflect real-time exchange rates after the currency exchange request has been submitted.

16. The method of claim 14, wherein the system is configured to allow the first user to lock in the exchange rate at the time the currency exchange rate request is submitted.

17. The method of claim 14, wherein the distance is 20 miles.

18. The system of claim 14, further comprising the step of providing a map indicating each second location identifier of the one or more second users within the distance of the first user.
